(19) United States
(12) Patent Application Publication
(10) Pub. No.: US 2019/0171749 A1
(43) Pub. Date: Jun. 6, 2019

(54) DATA INTEGRATION FRAMEWORK FOR MULTIPLE DATA PROVIDERS USING SERVICE URL

(71) Applicant: SAP SE, Walldorf (DE)

(72) Inventors: Vinutha Yediyur VaradarajaIyengar, Bangalore (IN); Mayank Manchanda, Faridabad (IN)

(21) Appl. No.: 15/830,276

(22) Filed: Dec. 4, 2017

(51) Int. Cl. G06F 17/30

(52) U.S. Cl. CPC G06F 17/30563; G06F 17/30477; G06F 17/30377

(57) ABSTRACT

A method and system are provided including a mapper module; a display; a memory storing processor-executable steps; and a mapper processor coupled to the memory, and in communication with the mapper module and operative to execute the processor-executable process steps to cause the system to: receive a link to a first data source, wherein the first data source is an external data source; parse data stored at the first data source; generate a mapper table based on the parsed data, wherein the mapper table includes at least one external data field associated with the parsed data; determine at least one target data field in a second data source, wherein the target data field corresponds to at least one external data field; map the at least one determined target data field to the corresponding external data field in the mapper table; and access the mapper table with an application during execution of the application. Numerous other aspects are provided.

### BACKGROUND

Data plays an important role in the operation of organizations, and may be used across all business processes. At times, existing data is not sufficient for identifying and/or analyzing problems and/or analyzing other operational aspects. When the existing data at the organization is not sufficient, it may be desirable to collect data from an external data provider. The conventional processes to acquire the data from external data providers are costly, at least in terms of time and resources.

Systems and methods are desired which support efficient acquisition of data from external data providers.

### BRIEF DESCRIPTION OF THE DRAWINGS

FIG. 1 is a block diagram of a system architecture according to some embodiments.

FIG. 2 is a flow diagram of a process according to some embodiments.

FIG. 3 is an outward view of a graphical interface according to some embodiments.

FIG. 4 is an outward view of a table according to some embodiments.

FIG. 5 is a block diagram of a system according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Conventionally, when a user wishes to integrate internal data and external data from a data provider for use in an application, the user cannot efficiently import the external data to their system. For example, if the external data provider includes table ABC, and the user wishes to integrate table ABC in their system, the user may be required to manually check each record in table ABC to determine whether each record is desirable for integration. Then, if it is desirable, the user may manually import each record individually. This may be a tedious and time-consuming process that may also be prone to user error.

Some embodiments may provide for the generation of a mapper table that dynamically maps data from an external data source to corresponding internal fields. Then, when an application is executed using the mapper table, both the data from the external data source that populates the table and the data from the internal data source may be supplied to the application.

As used herein, an “external data source” may be any suitable data provider outside of a target organization or user platform. As used herein, “target organization or user platform” may refer to the originating source of a data query, and the recipient of the data from the external data source. As used herein, a web browser is a software application for retrieving, presenting and traversing information resources provided by web servers (e.g., the World Wide Web or private networks or file systems). As used herein, a “computing device” may refer to any electronic equipment controlled by a central processing unit, including desktop and laptop computers, smart phones, tablets and any IoT device.

Some embodiments provide for the process to begin with an end user subscribing to, and registering with, an external data provider. In response to the registration, the end user may receive a link, such as a Uniform Resource Locator (URL), to access subscribed-to data at the external data provider. Other suitable links maybe provided. Then, the end user may query the external data provider for external data (i.e., data provided by the external data provider) via the link. A mapper module may receive the results of the query and may save the results of the query in a local storage. The results may include an external field (e.g., country) and an external data element associated with the external field (e.g., United States of America).

Next, the mapper module may create a mapper table including the received external fields associated with the received external data elements. The mapper module may then determine which internal data fields in an internal data source (i.e. target organization) correspond to the external data fields, and may map each external data field to a corresponding internal data field in the mapper table. In one or more embodiments, the internal and external data fields may represent objects or any other suitable data structure. In embodiments, the mapper table may be created prior to an application being executed, and may be populated with the internal and external data fields elements. The inventors note that a benefit of one or more embodiments is the acquisition of external data into an internal system may be faster and easier, and may require less resources than conventional processes of external data acquisition.

Benefits of one or more embodiments include: the mapper table may subsequently be used as a “plug-in” by any application requesting the particular data from the external data source; an end user is able to directly view the external data elements from the external data providers and bring that data into their own databases and applications. Embodiments may reduce the time and effort to map the fields between the internal system and the external data provider, as well as reduce the time for creating a master data table. Embodiments also may reliably provide the correct data in the correct field.

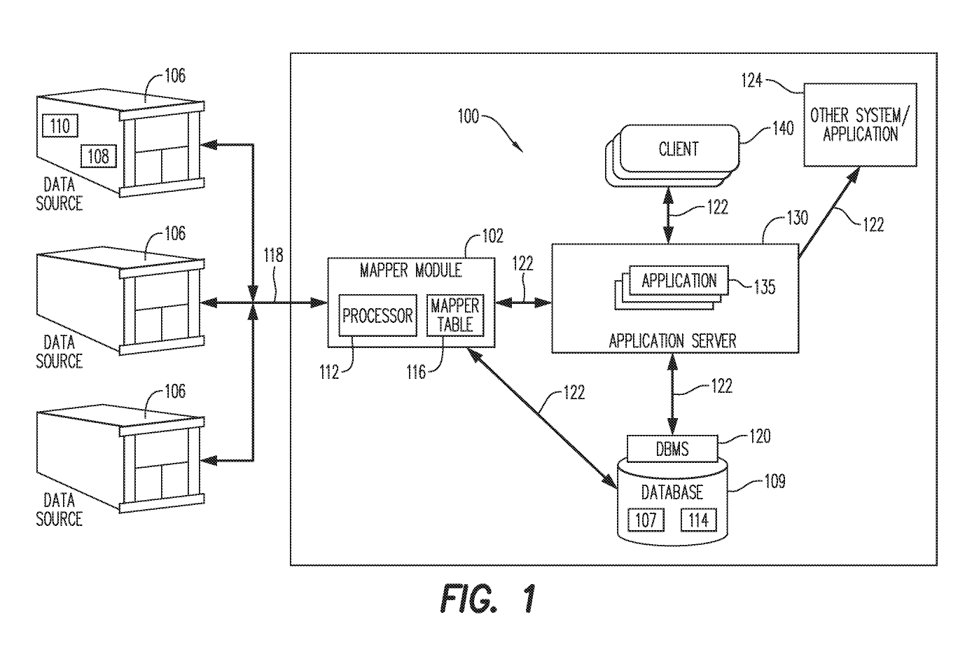

FIG. 1 is a block diagram of system architecture 100 according to some embodiments. Embodiments are not limited to architecture 100 or to a three-tier database architecture.

Architecture 100 includes a mapper module 102, a platform 104, database 109, database management system (DBMS) 120, application server 130, applications 135 and clients 140. Applications 135 may comprise server-side executable program code (e.g., compiled code, scripts, etc.) executing within application server 130 to receive queries from clients 140 and provide results to clients 140 or other systems/applications 124 based on data of database 109 and data from one or more external data sources 106 via the mapper module 102.

The external data source 106 may be any suitable data provider outside of a user platform 104. Examples of an external data source include, but are not limited to, Reuters, Dun & Bradstreet, etc. The external data source 106 may store external data elements 108 in one or more external data fields 110. For example, external data element “John,” may be stored in external data field “Name.” The data elements 108 may take the form of a JSON file, an XML file, or any other suitable format. In one or more embodiments, an end user (not shown) may register with the external data source 106 and subscribe to at least one external data field 110 provided by the external data source 106. Registration may provide the end user-accessible data fields 110, as well as examples of the type of data elements 108 stored in those fields (e.g., customer name, country names, etc.). In response to a query, the external data source 106 may provide one or more data elements 108 based on the end user's subscription.

The mapper module 102 may include a processor 112. The processor 112 may, for example, be a conventional microprocessor, and may operate to control the overall functioning of the mapper module 104. In one or more embodiments, the processor 112 may be programmed to receive external data elements 108 from the external data source 106 and dynamically generate a mapper table 116. The mapper table 116 may map the external data fields 110 and external data elements 108 to internal data fields 114, as described further below.

In one or more embodiments, the external data source 106 may provide a link 118 to the end user to access the external data source 106. The link 118 may be a uniform resource locator (URL) or any other suitable communication link to access the external data elements 108 stored at the external data source 106.

The link 118 may be stored in a table or any other suitable data storage structure in the database 110, for example, which may be maintained by the end user. The end user may modify the table storing the links (e.g., add or remove links), as needed. The inventors note that a benefit of the end user maintaining the links 118 is that it may be re-used across all of the applications, wherever applicable. Additionally, the central location for maintenance, may make it easier to manually modify the table, as needed. In one or more embodiments, an application 135 may rely on external data elements 108 provided by one or more external data sources 106, and as such, the table may include one or more links 118 to access the external data elements 108 provided by the one or more external data sources 106.

Database 109 may store internal data elements 107, external data elements 108, and their respective data fields 116, 110 (collectively “data”) used by applications 135. Database 109 may comprise any query-responsive data source or sources that are or become known, including but not limited to a structured-query language (SQL) relational database management system. Database 109 may comprise a relational database, a multi-dimensional database, an eXtendable Markup Language (XML) document, or any other data storage system storing structured and/or unstructured data. The data of database 109 may be distributed among several relational databases, dimensional databases, and/or other data sources. Embodiments are not limited to any number or types of data sources.

In some embodiments, the data of database 109 may comprise one or more of conventional tabular data, row-based data, column-based data, and object-based data. Moreover, the data may be indexed and/or selectively replicated in an index to allow fast searching and retrieval thereof. Database 109 may support multi-tenancy to separately support multiple unrelated clients by providing multiple logical database systems which are programmatically isolated from one another.

Database 109 may implement an “in-memory” database, in which a full database stored in volatile (e.g., non-disk-based) memory (e.g., Random Access Memory). The full database may be persisted in and/or backed up to fixed disks (not shown). Embodiments are not limited to an in-memory implementation. For example, data may be stored in Random Access Memory (e.g., cache memory for storing recently-used data) and one or more fixed disks (e.g., persistent memory for storing their respective portions of the full database).

Application server 130 may provide any suitable interfaces through which clients 140 may communicate with applications 135, and by extension the mapper module 102, executing on application server 130. For example, application server 130 may include a HyperText Transfer Protocol (HTTP) interface supporting a transient request/response protocol over Transmission Control Protocol/Internet Protocol (TCP/IP), a WebSocket interface supporting non-transient full-duplex communications which implement the WebSocket protocol over a single TCP/IP connection, and/or an Open Data Protocol (OData) interface.

One or more applications 135 executing on server 130 may communicate with DBMS 120 using database management interfaces such as, but not limited to, Open Database Connectivity (ODBC) and Java Database Connectivity (JDBC) interfaces. These types of applications 135 may use Structured Query Language (SQL) to manage and query data stored in database 109.

DBMS 120 serves requests to retrieve and/or modify data of database 109, and also performs administrative and management functions. Such functions may include snapshot and backup management, indexing, optimization, garbage collection, and/or any other database functions that are or become known. DBMS 120 may also provide application logic, such as database procedures and/or calculations, according to some embodiments. This application logic may comprise scripts, functional libraries and/or compiled program code.

Application server 130 may be separated from, or closely integrated with, DBMS 120. A closely-integrated application server 130 may enable execution of server applications 135 completely on the database platform, without the need for an additional application server. For example, according to some embodiments, application server 130 provides a comprehensive set of embedded services which provide end-to-end support for Web-based applications. The services may include a lightweight web server, configurable support for OData, server-side JavaScript execution and access to SQL and SQLScript.

Application server 130 may provide application services (e.g., via functional libraries) which applications 135 may use to manage and query the data of database 109 and the mapper module 102. The application services can be used to expose the database data model, with its tables, hierarchies, views and database procedures, as well as the mapper table 116 to clients. In addition to exposing the data model, application server 130 may host system services such as a search service.

Each client 140 may comprise one or more individuals or devices executing program code of a software application for presenting user interfaces to allow interaction with application server 130 and the mapper module 102. Presentation of a user interface as described herein may comprise any degree or type of rendering, depending on the type of user interface code generated by application server 130. As used herein, the terms “client” and “end user” may be used interchangeably.

For example, a client 140 may execute a Web Browser to request and receive a Web page (e.g., in HTML format) from a website application 135 of application server 130 per the URL link 118, via HTTP, HTTPS, and/or WebSocket, and may render and present the Web page according to known protocols. One or more of clients 140 may also or alternatively present user interfaces by executing a standalone executable file (e.g., an .exe file) or code (e.g., a JAVA applet) within a virtual machine. An end user may then query the external data source 106 from the web page or user interface per the URL link 118 to acquire external data elements 108 to generate the mapper table 116 and subsequently execute the application 135.

As used herein, devices, including those associated with the system 100 and any other devices described herein, may exchange information via any communication network which may be one or more of, a Near Field Communication (“NFC”) network; a Web Real-Time Communication (RTC) network; a Bluetooth network, and/or an Internet Protocol (“IP”) network such as the Internet, an intranet, or an extranet. Note that any devices described herein may communicate via one or more such communication networks.

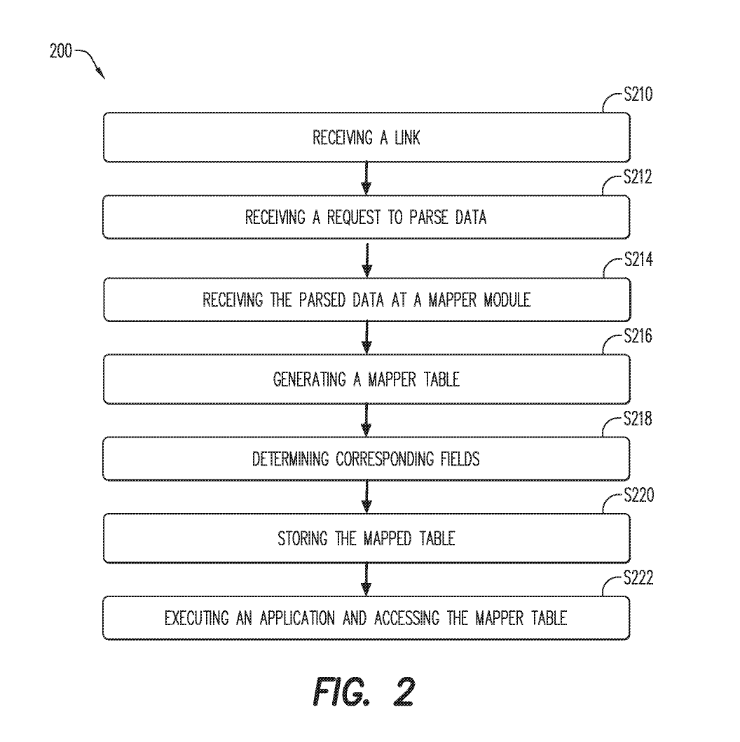

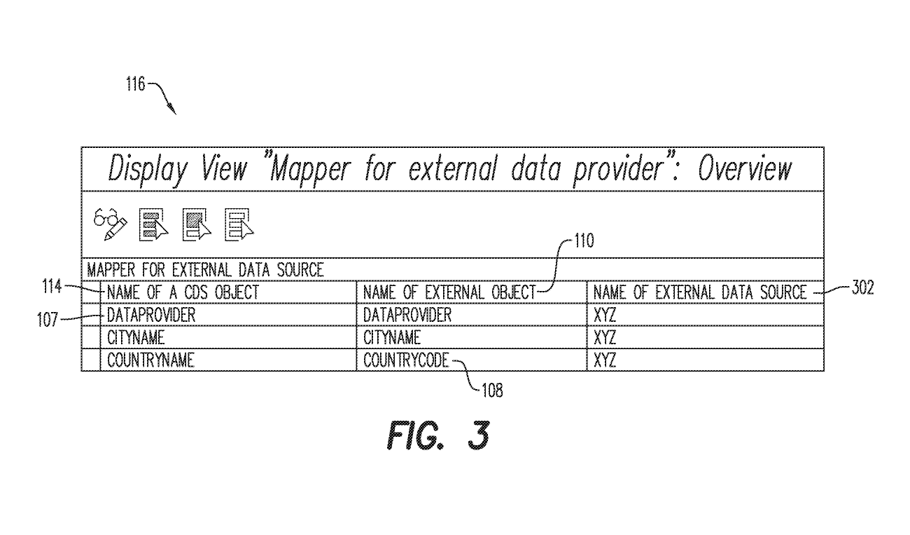

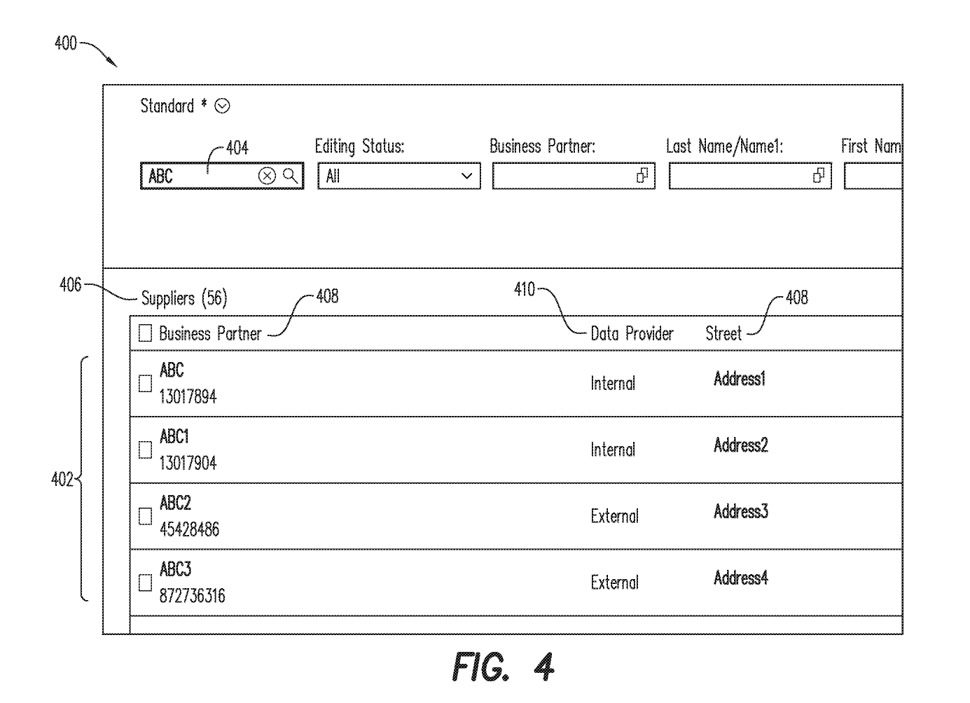

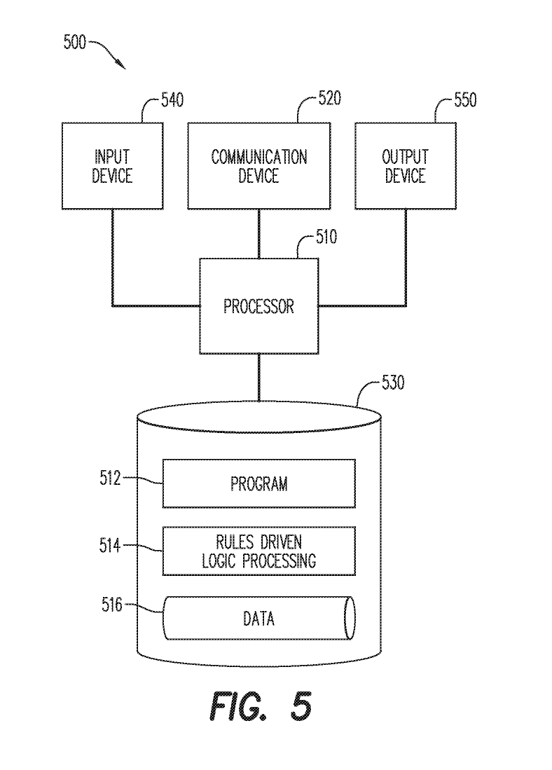

FIGS. 2-4 include a flow diagram of a process 200 (FIG. 2), a table (FIG. 3) and user interface display (FIG. 4) according to some embodiments. Process 200 may be executed by the mapper module 102 according to some embodiments, to provide a user with access to the table 116 300 (FIG. 3) and user interface 400 (FIG. 4). In one or more embodiments, the mapper module 102 may be conditioned to perform the process 200, such that the processor 112/510 (FIG. 5) is a special-purpose element configured to perform operations not performable by a general-purpose computer or device.

All processes mentioned herein may be executed by various hardware elements and/or embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software. Examples of these processes will be described below with respect to embodiments of the system, but embodiments are not limited thereto. The flow chart(s) described herein do not imply a fixed order to the steps and embodiments of the present invention may be practiced in any order that is practicable.

User interface 400 may be presented on any type of display apparatus (e.g., desktop monitor, smartphone display, tablet display) provided by any type of client device (e.g., desktop system, smartphone, tablet computer). The application which is executed to provide user interfaces 400 may comprise a Web Browser, a standalone application, or any other application. Embodiments are not limited to the user interface 400 of FIG. 4.

Initially at S210, a link 118 to an external data source 106 is received by an end user. As described above, prior to execution of the process, the end user may subscribe to, and register with, the external data source 106. As part of the subscription, the end user may be entitled to access particular external data elements 108 stored at the external data source 106. As part of the subscription and registration process, the end user may receive an indication of the type of data elements 108 they are subscribed to, and the external data field 106 associated with that external data element 108. For example, the end user may subscribe to member name and address for a particular organization. The data element “John” 108 may be stored in the external data field “name” 110, and data element “USA” 108 may be stored in the external data field “country name” 110.

In response to the registration, the end user may receive the link 118 to access subscribed-to data at the external data source 106. In one or more embodiments, the link 118 may be a Uniform Resource Locator (URL), or any other suitable link. The provision of the link 118 may be referred to as a “preliminary phase” of the process 200. The link 118 may be stored in the database 109. The inventors note that while non-exhaustive examples described herein relate to a single link 118, the end user may import data from more than one external data source 106, and therefore receive more than one link 118, which may be stored in the database 110. While maintenance of the actual URL may be provided by the external data source, the end user may maintain the table where the links are stored.

The following steps may be referred to as the “execution phase.”

Continuing with the process 200, in S212, a request is received at the external data source 106 to parse the data at the external data source 106 to one or more data elements. As used herein, “parsing” may refer to filtering the data at a data source based on execution of a query, were the parsing results in external data elements 108. The external data elements 108 may be all, or less than all of the subscribed-to data at the external data source 106. In one or more embodiments, the request may be received from the end user via the mapper module 102. For example, the end user may want to acquire data elements from the external data source 106 related to organization addresses. The end user may then select the appropriate link 118 from the database 109. In one or more embodiments, the link 118 may be a general link to the external data source 106. Once connected to the external data source 106, the end user may post a query to search for, and access, external data elements 108. In one or more embodiments, the query may be for data elements 108 or data fields 135. In one or more embodiments, the link 118 may dynamically change in response to the posted query to generate the external data elements 108. In response to the posted query, the external data source 106 may filter the data stored in the external data source 106, and provide the resulting external data fields 110 to the mapper module 102, and in some embodiments, may also provide the external data elements 108 to the mapper module 102.

Next, in S214, the parsed data is received by the mapper module 102 via the link 118. In one or more embodiments, the mapper module 102 may store the parsed data locally in the mapper module 102. In one or more embodiments, the parsed data may be stored in the database 109, in addition to being stored in the mapper module 102, or instead of being stored in the mapper module 102. The end user may access the parsed data to determine whether it the data is correct.

The mapper module 102 then generates a mapper table 116 in S216, based on the parsed data. In one or more embodiments, the mapper table 116 (FIG. 3) may provide a framework for linking the external data field 110 to internal data fields 114, such that when an application 135 calls for data elements from an internal data field 114, data elements from the internal data field and those in the corresponding/linked external data fields 110 are returned. In one or more embodiments, when the external data fields 110 are imported to, and received by, the mapper module 102, they may be stored in the mapper table 116. In one or more embodiments, the external data elements 108 in the external data fields 110 may be imported to the mapper table when the external data fields 110 are imported, or at a later time, as described further below. In one or more embodiments, the application 135 may use the mapper module 102 retrieve the relevant data elements. The mapper module 102 may then map the data elements to the calling application and not save the mapped data elements in the mapper module 102.

Then, for each external data field 110 stored in the mapper table 116, the mapper module 102 may determine at least one internal data field 114 (“target data field”) in the internal data source 101 stored in the database 109, for example, that corresponds to the external data field 110 in S218. As used herein, the terms “internal data field” and “target data field” may be used interchangeably.

In one or more embodiments, the mapper module 102 may determine the corresponding internal data field(s) 114 by searching the database 109 for any corresponding internal data fields 114. In one or more embodiments, the internal data field 114 and external data field 110 may each represent an object, or any other suitable data structure. For example, an external data field 110 of “country” may correspond to an internal data field 114 of “country.”.

In one or more embodiments, when the mapper module 102 cannot find a corresponding internal data field 114, the mapper module 102 may provide one or more suggestions to the end user. The suggestion may be provided in a pop-up window, or via any other suitable notification process. Continuing with the example provided above, for the external data field of “country,” the mapper module 102 may find three corresponding internal data fields 114: “Countryname1,” “Countryname2,” and “Countryname3.” The end user may be provided with a pop-up window allowing the end user to select one of these three internal data fields 114 to correspond with the external data field 110 of “country,” in the mapper table 116 or to select a different internal data field 114 to correspond with the external data field 110 of “country.”

Turning back to the process 200, after determining the corresponding internal data fields 114 in S218, the mapper module 102 maps the external data field 110 to the corresponding internal data field 114 in the mapper table 116. In one or more embodiments, the end user may access the mapper table 116 to review the mappings. For example, as shown in FIG. 3, the internal data field 103 of “DATAPROVIDER” maps to the external data field 110 “DATAPROVIDER.” The mapper table 116 may also provide an external data source name 302. While only one external data source is shown herein, embodiments may apply to more than one external data source.

The mapper table 116 including the mapped external data fields 110 and internal data fields 114 may then be stored in the database 109 in S220. In one or more embodiments, the mapped mapper table 116 may not be tied to a specific application 135, and instead may be accessible by any application that may need the data stored therein.

In one or more embodiments, after the mapper table 116, including the mapped external data fields 110 and internal data fields 103, is stored in the database 109 in S220, the data elements 107, 108 in the internal data fields 114 and external data fields 110 may be made available to at least one of an executing application 135, another system 124 and the end user.

According to one or more embodiments, the system 100 may execute program code of a software application for presenting interactive graphical user display interfaces to allow interaction with the resulting data elements.

For example, turning to FIG. 4, a non-exhaustive example of the data elements resulting from a query of the mapper table 116 is provided. The resulting data elements 402 may be provided to at least one of an end user, an executing application 135, or other system. As shown here, a query (“ABC) is included in a search field 404 of a user interface 400. Execution of the query provides the data elements 402 in a results section 406. In one or more embodiments, the results section 406 may organize the data elements 402 (e.g., ABC, ABC1, ABC2) by data field 408 (e.g., Business Partner and Street). In one or more embodiments, the data element 402 may include a record identification number of the record coming from the external data provider (e.g., for ABC, the record identification number is: 13017894). The results section 406, may, in one or more embodiments, include a data provider indicator 410 to indicate a source of the data elements (e.g., internal or external).

The data in the results section 406 may be transmitted to (and in some instances presented on) at least one of various user device platforms (not shown) or to other systems or applications 124 as appropriate (e.g., for display to, and manipulation by the end user). The user device platform may include, for example, a control system, a desktop computer, a laptop computer, a personal digital assistant, a tablet, a smartphone, etc. Other suitable user device platforms may be used. In one or more embodiments, one or more communication channels 122 may be included in the system 100 to supply data between the different entities in the system.

Turning back to the process 200, in S222, the mapper table 116 is accessed by an executing application 135. In one or more embodiments, the client 140 may call the application server 130 to execute the application 135. Then, during execution, the application 135 may access the mapper table 116 to acquire data elements associated with the one or more internal data fields 114 used in the execution of the application 135 to continue a particular process. As the internal data fields 114 are linked to the external data fields 110 in the mapper table 116, when the executing application 135 acquires the data elements associated with the one or more internal data fields 114, the executing application 135 may also acquire the data elements in the corresponding external data fields 110. In one or more embodiments, the executing application 135 may directly access the mapper table 116. In one or more embodiments, the data elements in the external data fields 110 may be populated when the application 135 is executed, or at a different time (e.g., before the application is executed, including when the table 116 is generated). When the application 135 is executed and the mapper table 116 is accessed, the mapper module 102 may contact the external data provider 106, via the link 118, to update the data elements in the external data fields 110 in one or more embodiments.

As a non-exhaustive example, an end user may want to integrate data provided by external data provider XYZ 106 to ABC application 135. Using the link 118, a few external data fields 110 from external data provider XYZ 106 may be exposed to the mapper module 102. The mapper module 102 may then read the data elements in those external data fields 110, in the form of an XML string, to generate the mapper table 116 dynamically consisting of the external data fields 110 from the external data provider XYZ 106 and the internal data fields 114 of a target ABC source 101. In one or more embodiments, the XML string may be parsed by the mapper module 102 to retrieve the data elements 108 and then the data elements 108 may be mapped in the mapper table 116 in the format relevant for the ABC application 135. Next, in one or more embodiments, the data elements provided by the external data provider XYZ 106 may be updated in the ABC application 135. For example, the external data providers may include multiple records. Using the mapper table 116 and search query, the multiple records may be provided by the external providers. These records may then be updated in the corresponding application.

All processes mentioned herein may be executed by various hardware elements and/or embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

FIG. 5 is a block diagram of apparatus 500 according to some embodiments. Apparatus 500 may comprise a general- or special-purpose computing apparatus and may execute program code to perform any of the functions described herein. Apparatus 500 may comprise an implementation of one or more elements of system 100. Apparatus 500 may include other unshown elements according to some embodiments.

Apparatus 500 includes mapper processor 510 operatively coupled to communication device 520, data storage device 530, one or more input devices 540, one or more output devices 550 and memory 560. Communication device 520 may facilitate communication with external devices, such as application server 130. Input device(s) 540 may comprise, for example, a keyboard, a keypad, a mouse or other pointing device, a microphone, knob or a switch, an infra-red (IR) port, a docking station, and/or a touch screen. Input device(s) 540 may be used, for example, to manipulate graphical user interfaces and to input information into apparatus 500. Output device(s) 550 may comprise, for example, a display (e.g., a display screen) a speaker, and/or a printer.

Data storage device/memory 530 may comprise any device, including combinations of magnetic storage devices (e.g., magnetic tape, hard disk drives and flash memory), optical storage devices, Read Only Memory (ROM) devices, Random Access Memory (RAM) etc.

The storage device 530 stores a program 512 and/or mapper platform logic 514 for controlling the processor 510. The processor 510 performs instructions of the programs 512, 514, and thereby operates in accordance with any of the embodiments described herein, including but not limited to process 200.

The programs 512, 514 may be stored in a compressed, uncompiled and/or encrypted format. The programs 512, 514 may furthermore include other program elements, such as an operating system, a database management system, and/or device drivers used by the processor 510 to interface with peripheral devices.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of computing devices in communication with one another via any number of other public and/or private networks. Two or more of such computing devices may be located remote from one another and may communicate with one another via any known manner of network(s) and/or a dedicated connection. Each computing device may comprise any number of hardware and/or software elements suitable to provide the functions described herein as well as any other functions. For example, any computing device used in an implementation of system 100 may include a processor to execute program code such that the computing device operates as described herein.

All systems and processes discussed herein may be embodied in program code stored on one or more computer-readable non-transitory media. Such media non-transitory media may include, for example, a fixed disk, a floppy disk, a CD-ROM, a DVD-ROM, a Flash drive, magnetic tape, and solid-state RAM or ROM storage units. Embodiments are therefore not limited to any specific combination of hardware and software.

The embodiments described herein are solely for the purpose of illustration. Those in the art will recognize other embodiments may be practiced with modifications and alterations limited only by the claims.

What is claimed is:

1. A system comprising:
a mapper module;
a display;
a memory storing processor-executable steps; and
a mapper processor coupled to the memory, and in communication with the mapper module and operative to execute the processor-executable process steps to cause the system to:
receive a link to a first data source, wherein the first data source is an external data source;
parse data stored at the first data source;
generate a mapper table based on the parsed data, wherein the mapper table includes at least one external data field associated with the parsed data;
determine at least one target data field in a second data source, wherein the target data field corresponds to at least one external data field;
map the at least one determined target data field to the corresponding external data field in the mapper table; and
access the mapper table with an application during execution of the application.

2. The system of claim 1, wherein the link is a Uniform Resource Locator (URL).

3. The system of claim 1, wherein parsing further comprises processor-executable steps to cause the system to:
request at least one of one or more data fields and one or more data elements from the first data source.

4. The system of claim 3, wherein generating the mapper table further comprises processor-executable steps to cause the system to:
import the external data field of each data element provided by the first data source to the mapper table.

5. The system of claim 1, wherein executing the application further comprising processor-executable steps to cause the system to:
query the first data source for one or more data elements associated with the external data field in the mapper table;
receive the one or more data elements from the first data source in response to the query; and
receive one or more data elements from the second data source.

6. The system of claim 5, further comprising processor-executable steps to cause the system to:
display the one or more received data elements.

7. The system of claim 6, wherein the each received data element includes a data provider indicator.

8. The system of claim 5, further comprising processor-executable steps to cause the system to:
transmit the one or more received data elements directly to a second application.

9. A computer-implemented method comprising:
parsing data stored at a first data source, wherein the first data source is an external data source;
generating a mapper table based on the parsed data, wherein the mapper table includes at least one external data field associated with the parsed data;
determining at least one target data field in a second data source, wherein the target data field corresponds to at least one external data field;
mapping the at least one determined target data field to the corresponding external data field in the mapper table; and
accessing the mapper table with an application during execution of the application.

10. The method of claim 9, further comprising:
receiving a link to the first data source prior to parse the data.

11. The method of claim 9, wherein the link is a Uniform Resource Locator (URL).

12. The method of claim 9, wherein parsing further comprises:
requesting one or more data elements from the first data source.

13. The method of claim 12, wherein generating the mapper table further comprises:
importing the external data field of each data element provided by the first data source to the mapper table.

14. The method of claim 9, wherein executing the application further comprises:
querying the first data source for one or more data elements associated with the external data field in the mapper table;
receiving the one or more data elements from the first data source in response to the query; and
receiving one or more data elements from the second data source.

15. The method of claim 14, further comprising:
displaying the one or more received data elements.

16. The method of claim 14, further comprising:
transmitting the one or more received data elements directly to a second application.

17. A non-transitory computer-readable medium storing program code, the program code executable by a computer system to cause the computer system to:
receive a link to a first data source, wherein the first data source is an external data source;
request one or more data items from the first data source;
generate a mapper table based on the parsed data, wherein the mapper table includes at least one external data field associated with the parsed data;
determine at least one target data field in a second data source, wherein the target data field corresponds to at least one external data field;
map the at least one determined target data field to the corresponding external data field in the mapper table; and
access the mapper table with an application during execution of the application.

18. The medium of claim 17, wherein the link is a Uniform Resource Locator (URL).

19. The medium of claim 17, wherein generating the mapper table further comprises program code to cause the system to:
import the external data field of each data element provided by the first data source to the mapper table.

20. The medium of claim 17, wherein executing the application further comprising program code to cause the system to:
query the first data source for one or more data elements associated with the external data field in the mapper table;
receive the one or more data elements from the first data source in response to the query; and
receive one or more data elements from the second data source.
